(19) United States
(12) Patent Application Publication
(10) Pub. No.: US 2016/0045024 A1
(43) Pub. Date: Feb. 18, 2016

(54) PIVOTING FISHING ROD STAND

(71) Applicants: Johnathan David Roberts, Saint Simons Island, GA (US); James Leon Roberts, Blackshear, GA (US)

(72) Inventors: Johnathan David Roberts, Saint Simons Island, GA (US); James Leon Roberts, Blackshear, GA (US)

(21) Appl. No.: 14/824,300

(22) Filed: Aug. 12, 2015

Related U.S. Application Data
(60) Provisional application No. 62/037,896, filed on Aug. 15, 2014.

(51) Int. Cl. A47B 81/00; A47F 7/00; A01K 97/10

(52) U.S. Cl. CPC A47B 81/005; A01K 97/10; A47F 7/0028

(57) ABSTRACT

A fishing rod stand is provided. The fishing rod stand includes a base member and a pivoting member pivotally secured to the base member. The base member includes a top end and a bottom end opposite the top end. A plurality of tubes are secured to the base member. The plurality of tubes are sized to receive at least a portion of a handle of a fishing rod. The pivoting member includes an expanded position and a retracted position. The expanded position includes the pivoting member pivoted away from the base member and supporting the base member in an upright angled position when resting on a surface. The retracted position includes the pivoting member pivoted towards the base member.

### CROSS-REFERENCE TO RELATED APPLICATION

This application claims the benefit of priority of U.S. provisional application No. 62/037,896, filed Aug. 15, 2014, the contents of which are herein incorporated by reference.

### BACKGROUND OF THE INVENTION

The present invention relates to a fishing rod stand and, more particularly, to a pivoting fishing rod stand for storage and transportation of fishing rods.

A fishing rod is a long, flexible length of glass fiber composite, carbon fiber composite or, classically, bamboo, used to catch fish. In contrast with subsistence and commercial fishing, which usually involve nets, fishing rods are typically used in recreational fishing and competitive casting. Typically, fisherman transport and store multiple fishing rods. Fishing rods tend to take up space, may be disorganized, and may break during transportation and storage. Further, when fishing with multiple rods, fisherman may have to make more than one trip from their land vehicle to their boat.

As can be seen, there is a need for a fishing rod stand that consolidates more than one fishing rod.

### SUMMARY OF THE INVENTION

In one aspect of the present invention, a fishing rod stand comprises: a base member comprising a top end and a bottom end; a plurality of tubes secured to the base member, wherein each of the plurality of tubes is sized to receive at least a portion of a handle of a fishing rod; and a pivoting member pivotally secured to the base member, wherein the pivoting member comprises an expanded position comprising the pivoting member pivoted away from the base member and supporting the base member in an upright angled position when resting on the surface, and a retracted position comprising the pivoting member pivoted towards the base member.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a front perspective view of an embodiment of the present invention;

FIG. 3 is a rear perspective view of an embodiment of the present invention;

FIG. 4 is a perspective view of the present invention shown in use with an expanded pivoting member supporting the base member in an upright angled position;

FIG. 5 is a section detail view of the present invention along line 5-5 in FIG. 4; and

FIG. 6 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fishing rod rack for storage and transportation. The present invention holds rods securely in place preventing the rods from falling over during storage or banging together during transport. The rack may neatly organize fishing rods so that the rods take up minimal space. The rack is portable so that all of the stored rods can be moved simultaneously allowing users to transport more than one pole from a car or truck to a boat. Further, the present invention is freestanding and can be used for storage and transportation in a car, truck, or boat.

The device functions by securely holding fishing rods in a freestanding portable rack that can be transitioned from an upright storage mode to an angled transport position. The rod tubes securely support the rods because the rod tubes are rigidly fastened to the main frame. The rod tubes allow the fishing rod to slide down into the tube so that the reel is resting on top of the tube. Gravity holds the rod and reel securely in place so that the rod cannot come out of the tube unless one picks the rod and reel upward until the bottom end of the rod is higher than the top edge of the tube.

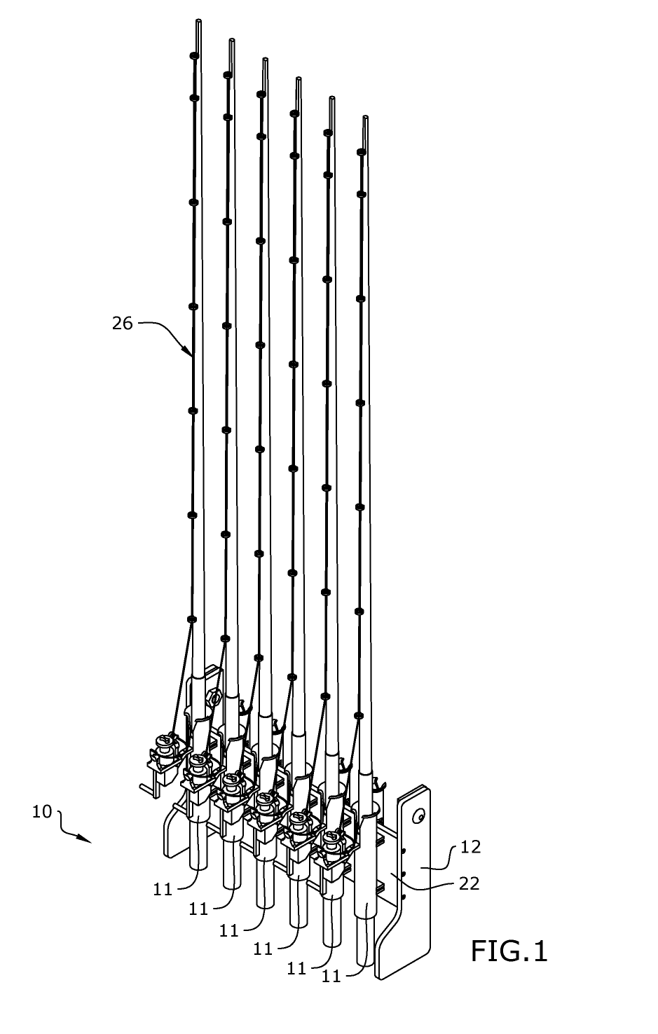

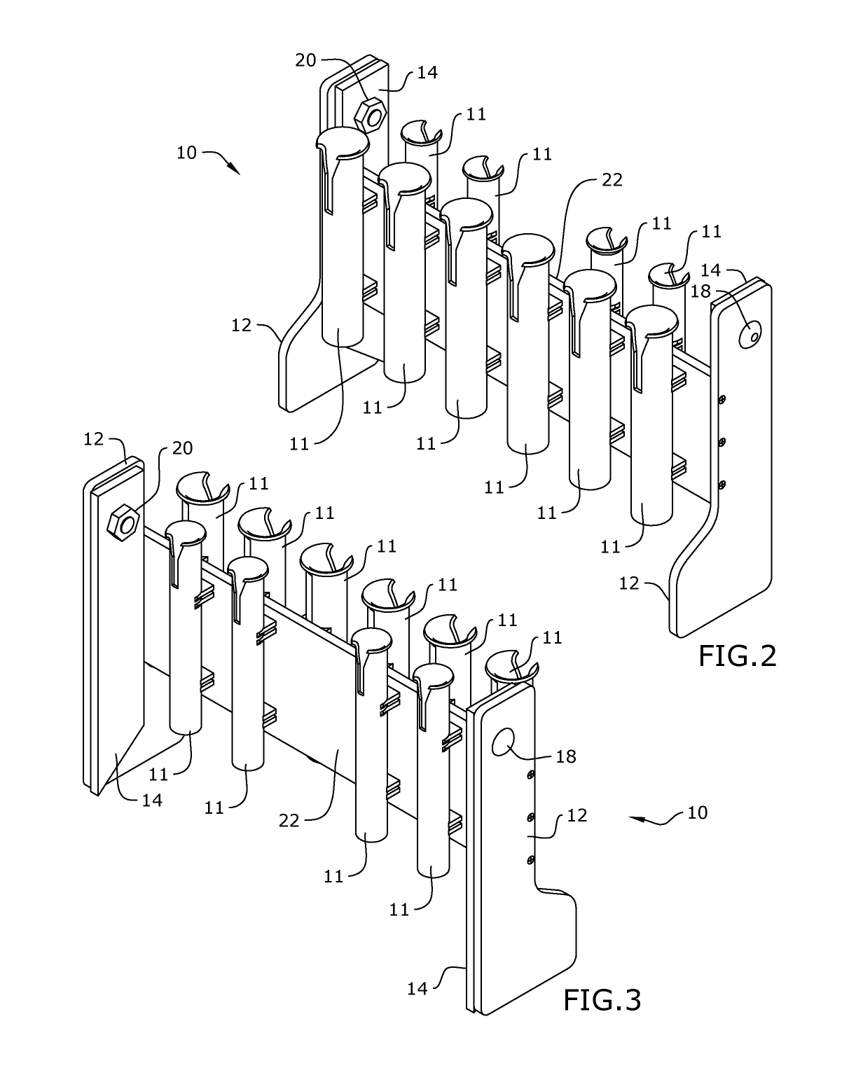

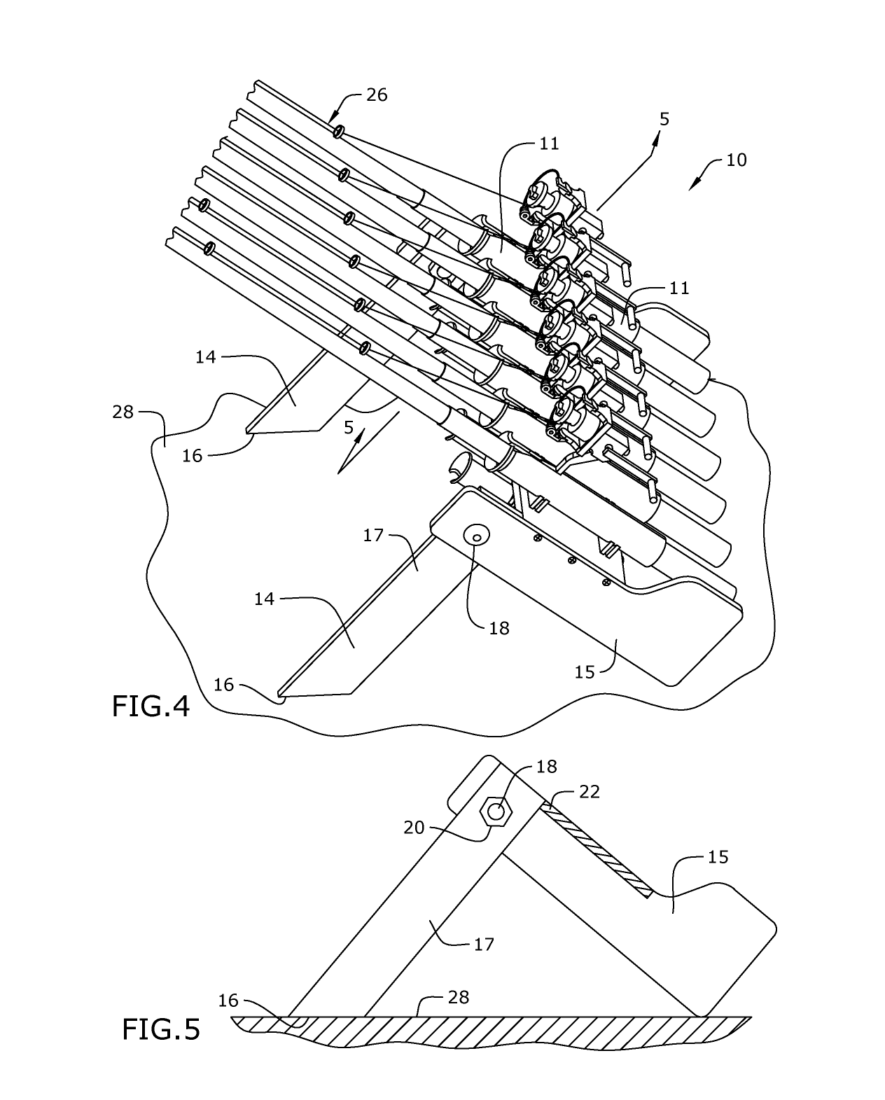

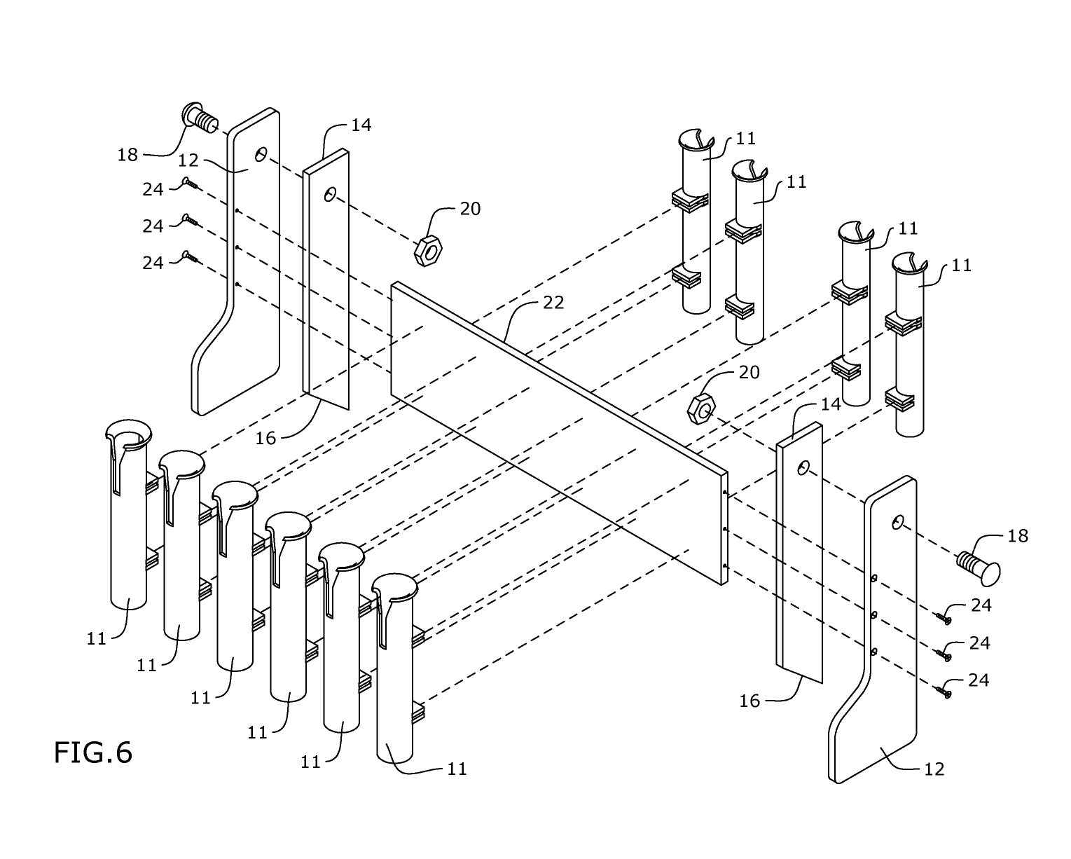

Referring to FIGS. 1 through 6, the present invention includes a fishing rod stand 10. The fishing rod stand 10 includes a base member 15 and a pivoting member 17 pivotally secured to the base member 15. The base member 15 includes a top end and a bottom end opposite the top end. A plurality of tubes 11 are secured to the base member 15. The plurality of tubes 11 are sized to receive at least a portion of a handle of a fishing rod 26. The pivoting member 17 includes an expanded position and a retracted position. The expanded position includes the pivoting member 17 pivoted away from the base member 15 and supporting the base member in an upright angled position when resting on a surface 28. The retracted position includes the pivoting member 17 pivoted towards the base member 15. As illustrated in FIG. 1, the bottom end of the base member 15 may be shaped to support the base member 15 in an upright vertical position when resting on the surface 28 in the retracted position.

The base member 15 of the present invention may include a first base leg 12, a second base leg 12 and a center beam 22. The center beam 22 may attach the first base leg 12 and the second base leg 12 together. In certain embodiments, the center beam 22 may be a substantially flat board having a front surface and a rear surface. The first and second base legs 12 may also be substantially flat boards that are substantially perpendicular to the center beam 22. The first base leg 12 and the second base leg 12 may each include feet at the bottom that have a greater width than the top ends. The length and width of the cross section of the feet is sufficient for vertical and lateral stability. The feet may have a substantially flat bottom to support the base member 15 in the upright vertical position when resting on the surface 28.

The pivoting member 17 of the present invention may be pivotally secured to the base member 15 near the top end. The pivoting member 17 may pivot at about 90 degrees relative to the base member 15 in the expanded position. In certain embodiments, the pivoting member may include a first pivoting leg 14 and a second pivoting leg 14. The first pivoting leg 14 may be pivotally secured to an inner surface of the first base leg 12 and the second pivoting leg 14 may be pivotally secured to an inner surface of the second base leg 12. The first pivoting leg 14 and the second pivoting leg 14 may each includes an angled flat bottom 16 to support the fishing rod stand 10 in the upright angled position. For example, each of the pivoting legs 14 may include a cut out portion at about a 45 degree angle.

In certain embodiments, the plurality of tubes 11 are secured to the center beam 22. The plurality of tubes 11 may each include an upper rim forming an entrance into the tubes 11. The upper rim may be disposed near the top end of the base member 15. A slot may be formed from an upper rim extending downward. The slot is sized to receive a portion of a support arm of a reel, thereby preventing the rods 26 from rotating when inside the tubes 11. The plurality of tubes 11 may include variable diameters to fit different sized fishing poles 26. In certain embodiments, a set of small diameter tubes 11 are secured to a front surface of the center beam 22 and a set of large diameter tubes 11 are secured to a rear surface the center beam 22.

A method of making the present invention may include the following. The plurality of tubes 11 are screwed or bolted to the center beam 22. The base legs 12 may be screwed or bolted to the ends of center beam 22 by fasteners 24. The pivoting legs 14 may be pivotally bolted to the base legs 12 by a bolt 18 and a nut 20. When the device is used for storage, the fishing rod stand 10 is positioned upright so that it is supported by the base legs 12 with lateral support from the wide bottom edge of the base legs 12. The rod tubes 11 are perpendicular to the ground in this mode. In transportation mode, the pivoting legs 14 are rotated ninety degrees with a pivot point near the top of the device so that the pivoting legs 14 brace against the center beam 22. The device is rotated forward so that it is supported by both the base legs 12 and pivoting legs 14. In this configuration, the pivoting legs 14 act as the front legs and the base legs 12 act as the back legs. The rod tubes 11 in this position are at about a 40 degree angle from the ground.

It should be understood, of course, that the foregoing relates to exemplary embodiments of the invention and that modifications may be made without departing from the spirit and scope of the invention as set forth in the following claims.

What is claimed is:

1. A fishing rod stand comprising:
a base member comprising a top end and a bottom end;
a plurality of tubes secured to the base member, wherein each of the plurality of tubes is sized to receive at least a portion of a handle of a fishing rod; and
a pivoting member pivotally secured to the base member, wherein
the pivoting member comprises an expanded position comprising the pivoting member pivoted away from the base member and supporting the base member in an upright angled position when resting on a surface, and a retracted position comprising the pivoting member pivoted towards the base member.

2. The fishing rod stand of claim 1, wherein the bottom end is shaped to support the base member in an upright vertical position when resting on a surface

3. The fishing rod stand of claim 1, wherein the pivoting member is pivotally secured to the base member near the top end and pivots about 90 degrees relative to the base member in the expanded position.

4. The fishing rod stand of claim 1, wherein the base member comprises a first base leg, a second base leg, and a center beam attaching the first base leg and the second base leg together

5. The fishing rod stand of claim 4, wherein the first base leg and the second base leg each comprise a substantially flat bottom to support the base member in the upright vertical position when resting on the surface.

6. The fishing rod stand of claim 4, wherein the plurality of tubes are secured to the center beam

7. The fishing rod stand of claim 4, wherein plurality of tubes comprise variable diameters.

8. The fishing rod stand of claim 7, wherein a set of small diameter tubes are secured to a front surface of the center beam and a set of large diameter tubes are secured to a rear surface the center beam.

9. The fishing rod stand of claim 1, wherein each of the plurality of tubes comprise a slot formed from an upper rim extending downward and are sized to receive a portion of a support arm of a reel.

10. The fishing rod stand of claim 4, wherein the pivoting member comprises a first pivoting leg and a second pivoting leg.

11. The fishing rod stand of claim 10, wherein the first pivoting leg is pivotally secured to an inner surface of the first base leg and the second pivoting leg is pivotally secured to an inner surface of the second base leg.

12. The fishing rod stand of claim 10, wherein the first pivoting leg and the second pivoting leg comprise an angled flat bottom to support the fishing rod stand in the upright angled position.
